(19) United States
(12) Patent Application Publication
(10) Pub. No.: US 2019/0097378 A1
(43) Pub. Date: Mar. 28, 2019

(54) METHOD FOR DESIGNING DIELECTRIC RESONATOR

(71) Applicant: Kyungpook National University Industry-Academic Cooperation Foundation, Daegu (KR)

(72) Inventor: Muhan Choi, Daegu (KR)

(73) Assignee: Kyungpook National University Industry-Academic Cooperation Foundation, Daegu (KR)

(21) Appl. No.: 16/136,435

(22) Filed: Sep. 20, 2018

(30) Foreign Application Priority Data
Sep. 26, 2017 (KR) 10-2017-0124566

(51) Int. Cl. H01S 3/08; G06F 17/50

(52) U.S. Cl. CPC H01S 3/08018; G06F 2217/16; G06F 17/5018

(57) ABSTRACT

A method for designing a non-circular dielectric resonator is provided. The method includes obtaining a conformal transformation coordinate of the non-circular dielectric resonator to correspond to a rectangular coordinate system of a circular dielectric resonator, mapping the obtained conformal transformation coordinate to the non-circular dielectric resonator, and setting a refractive index in the non-circular resonator and allowing an incident angle of light to satisfy a condition for total reflection in each of boundary areas in a non-circular dielectric resonator to which the conformal transformation coordinate is mapped.

### CROSS-REFERENCE TO RELATED APPLICATION

This application is based on and claims priority under 35 U.S.C. § 119(a) of a Korean Patent Application number 10-2017-0124566, filed on Sep. 26, 2017, in the Korean Intellectual Property Office, and the disclosure of which is incorporated by reference herein in its entirety.

### BACKGROUND

### 1. Field

The disclosure relates to a method for designing a dielectric resonator. More particularly, the disclosure relates to a method for designing a non-circular dielectric resonator for holding light for a long time and outputting light having a direction.

### 2. Description of Related Art

An optical resonator used to increase an intensity of incident light may cause a resonance phenomenon and hold an electromagnetic wave of a particular oscillation frequency or light for a predetermined time. The resonance phenomenon refers to a phenomenon in which an amplitude of a wave is largely increased when a natural frequency of some affiliation and an oscillation frequency of an external driving wave are identical to each other and the energy is increased. Accordingly, the optical resonator may be a core device of a laser.

To hold the light for a long time, the resonator is made into a circle, and a principle of “whispering gallery mode (WGM)” is used in a circular resonator. The “whispering gallery mode” derived from a gallery in which drawings are exhibited around the dome of St. Paul's Cathedral in England refers to a resonance phenomenon in which a total reflection of light occurs according to a boundary of a circular resonator as similar to a transfer of a little sound whispered with a person next is heard from a person on the other side at a far distance along a surface of a dome wall and the light is held in the resonator for a very long time by the total reflection. The total reflection refers to a phenomenon in which a light is totally refracted without being refracted when the light is incident from a medium of a large refractive index toward a medium of a small refractive index.

However, a light of a high quality factor (Q-factor) may be gathered in a circular dielectric resonator due to occurrence of a resonance phenomenon; however, since the circular dielectric resonator has a symmetrical structure, the light is uniformly output to the outside of the resonator. The light is uniformly output to the outside of the resonator and thus, there is a problem that the availability of a circular dielectric resonator is deteriorated.

To overcome the above-mentioned problem, research has been conducted for a long time to change the resonator into a distorted, non-circular shape rather than a circular shape. However, when a shape of a resonator is deformed into a distorted, non-circular shape, a damage to the “whispering gallery mode” useful in the development of a subminiature laser, an ultrasensitive biosensor, and various optomechanical devices occurs and as a result, the Q-factor is inevitably lowered. There is a problem that the lowered Q-factor deteriorates a frequency resolution of light and that the light of which the frequency resolution is lowered is emitted from the inside of a non-circular dielectric resonator to the outside.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for designing a non-circular dielectric resonator which is capable of maintaining a high Q-factor, and providing a method for designing a non-circular dielectric resonator to allow energy gathered in the non-circular dielectric resonator to have a directionality when escaping outside the resonator.

In accordance with an aspect of the disclosure, a method for designing a non-circular dielectric resonator is provided. The method includes obtaining a conformal transformation coordinate of the non-circular dielectric resonator to correspond to a rectangular coordinate system of a circular dielectric resonator, mapping the obtained conformal transformation coordinate to the non-circular dielectric resonator, and setting a refractive index in the non-circular resonator and allowing an incident angle of light to satisfy a condition for total reflection in each of boundary areas in a non-circular dielectric resonator to which the conformal transformation coordinate is mapped.

The method may further include tunnel-emitting the light outside from a boundary area of which the refractive index is lowest from among boundary areas of the non-circular dielectric resonator.

Refractive indexes in the non-circular resonator have different values.

The setting the refractive index in the non-circular resonator may include setting the refractive index by adjusting at least one of a permittivity and a permeability.

The non-circular dielectric resonator may have a shape of one of a limacon, an oval, and a curve of constant width

According to the various example embodiments, the “whispering gallery-mode (WGM)” is not deteriorated even in a non-circular dielectric resonator and thus, the same resonance phenomenon as a circular dielectric resonator may occur and a high Q-factor may be maintained.

The light gathered in a non-circular dielectric resonator according to an example embodiment may have a directionality and escape from the resonator.

The effects of an example embodiment of the disclosure is not to be limited to the effects mentioned above, and other effects not mentioned above may be clearly understood by those skilled in the art from various example embodiments below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above and other aspects, and advantages of certain embodiments of the disclosure will be more apparent from the following description taken in conjunction with the accompanying drawings, in which:

FIG. 1 is a flowchart provided to explain a method for designing a dielectric resonator, according to an example embodiment;

FIGS. 2A, 2B and 2C illustrate circular resonators of a homogeneous refractive index;

FIGS. 3A, 3B, 3C and 3D illustrate a dielectric resonator which is deformed to a limacon shape, according to various example embodiments;

FIGS. 4A, 4B and 4C illustrate a result of comparison of a dielectric resonator of a limacon shape of which a refractive set is set with a dielectric resonator of a limacon shape of a homogeneous refractive index, according to various example embodiments;

FIGS. 5A, 5B and 5C illustrate a bidirectional emission characteristic of a light in a dielectric resonator deformed to a limacon shape, according to various example embodiments;

FIGS. 6A, 6B and 6C illustrate a unidirectional emission characteristic of a light in a dielectric resonator deformed to a triangular, constant-width shape, according to various example embodiments;

FIGS. 7A, 7B, 7C and 7D illustrate figures in which a WGM and a cWGM in a resonator implemented by a hole and a post are numerically realized; and

FIGS. 8A, 8B and 8C illustrate a shape and intensity pattern of a resonator deformed to a triangular, constant-width shape implemented using an alumina post at a micro-frequency.

### DETAILED DESCRIPTION

Hereinafter, certain example embodiments will now be explained in detail with reference to the accompanying drawings. Other aspects, advantages, and salient features of the disclosure will become apparent to those skilled in the art from the following detailed description, which, taken in conjunction with the annexed drawings, discloses various embodiments of the disclosure. The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness. The terms and words used in the following description and claims are not limited to the bibliographical meanings, but, are merely used by the inventor to enable a clear and consistent understanding of the disclosure. Accordingly, it should be apparent to those skilled an the art that the following description of various embodiments of the disclosure is provided for illustration purpose only and not for the purpose of limiting the disclosure as defined by the appended claims and their equivalents. Throughout the specification, like reference numerals will be understood to refer to like parts, components, and structures.

The terms used to describe various embodiments are exemplary. It should be understood that these are provided to merely aid the understanding of the description, and that their use and definitions in no way limit the scope of the disclosure. The terms defined in a commonly-used dictionary are not to be ideally or excessively unless they are obviously defined in the dictionary.

In the description, the term “has”, “may have”, “includes” or “may include” indicates existence of a corresponding feature (e.g., a numerical value, a function, an operation, or a constituent element such as a component), but does not exclude existence of an additional feature.

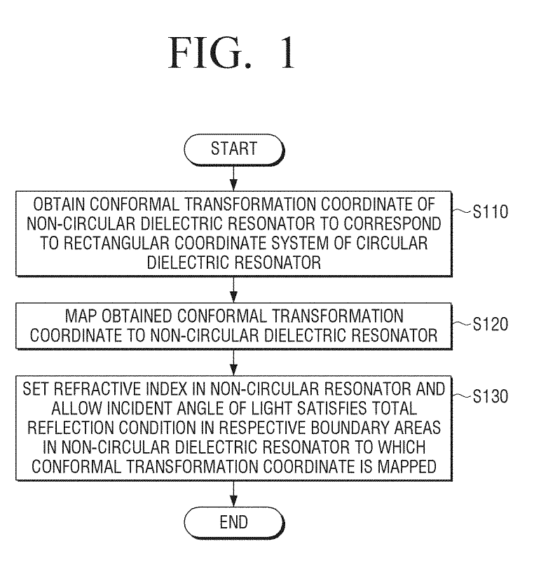

FIG. 1 is a flowchart provided to explain a method for designing a dielectric resonator, according to an example embodiment.

Referring to FIG. 1, in a method for designing a non-circular dielectric resonator(or cavity) according to an example embodiment, a conformal transformation coordinate of a non-circular resonator is obtained to correspond to a rectangular coordinate system of a circular dielectric resonator, at operation S110.

A conformal mapping may be used to obtain a conformal transformation coordinate of a non-circular dielectric resonator corresponding to the rectangular coordinate system of the circular dielectric resonator.

The conformal mapping is a mathematical conversion in which an angle is maintained in a two-dimensional surface. When the conformal mapping is used to obtain a conformal conversion coordinate of a non-circular dielectric resonator according to an example embodiment, a size of an angle formed by a path of light at a circular dielectric resonator may be maintained the same as a size of an angle formed by a path of light at the non-circular dielectric resonator.

A conformal transformation coordinate obtained by the method described above may be mapped with a non-circular dielectric resonator, at operation S120. A refractive index in a non-circular dielectric resonator is set such that an angle of incident of light satisfies a total reflection condition in the respective boundary areas within a non-circular dielectric resonator to which a conformal transformation coordinate is mapped.

The transformation optics theory, which is a theory to adjust a path of light by a refractive index control according to a space of which a coordinate has been converted, may be applied in design of a non-circular dielectric resonator according to an example embodiment.

The transformation optics theory departs from the theory of relativity of Albert Einstein stating that when a space through which a light is diffused is distorted, the light is curved according to a distorted space. The path of light which is curved by gravity may be emulated in dielectric materials having optical material parameters that may be varied according to spaces. A motion of all electromagnetic fields are defined by the Maxwell's equation. When a space in which an electromagnetic field moves is changed, the Maxwell's equation is not changed and only constants for permittivity and magnetic permeability are changed. The transformation optics theory is a theory which uses the above-mentioned property of the electromagnetic field the opposite way and controls a space in which the electromagnetic field moves by adjusting the permittivity and the magnetic permeability. The transformation optics theory is a field of research of meta materials. The meta materials are materials which has a new optical characteristic not present in the natural world, which may include optical material, such as an in visibility cloak.

Through application of the transformation optics theory to which the conformal mapping is introduced, refractive indexes within a non-circular dielectric resonator according to an example embodiment may be set. The refractive indexes within the non-circular dielectric resonator may be set to have different values. The refractive indexes within the non-circular dielectric resonator may be set by adjusting any one of the permittivity and the permeability.

By setting of a refractive index, total reflection of light may occur not only in a circular resonator but also in a non-circular dielectric resonator. Accordingly, the “whispering gallery mode” may occur in the non-circular dielectric resonator and thus, a high Q-factor may be maintained and a time for which the light stays may be approximately a thousand times longer than a non-circular dielectric resonator according to the related art. The Q-factor refers to a quantitative index indicating how long the light is held in a resonator.

Unlike a circular resonator, a non-circular dielectric resonator for which a refractive index distribution is set according to an example embodiment may have a broken symmetry of rotation and thus, the light with a directionality may be output. A non-circular shape may be designed in any one of a limacon, an oval, and a constant-width curve.

Accordingly, a dielectric resonator of a non-circular shape for which a refractive index is set may exhibit a high Q-value similar to that exhibited by a circular resonator. In addition, when outputted outside of a non-circular dielectric resonator, the light may be output to have a directionality.

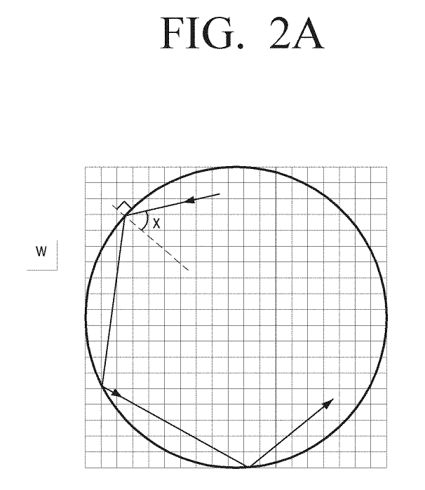

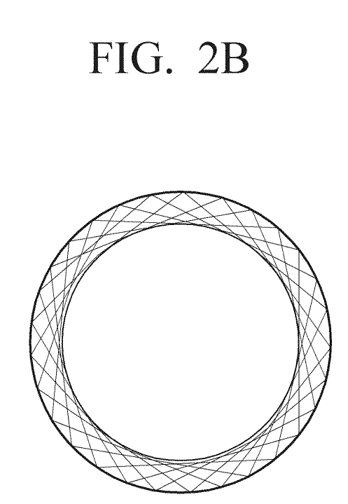

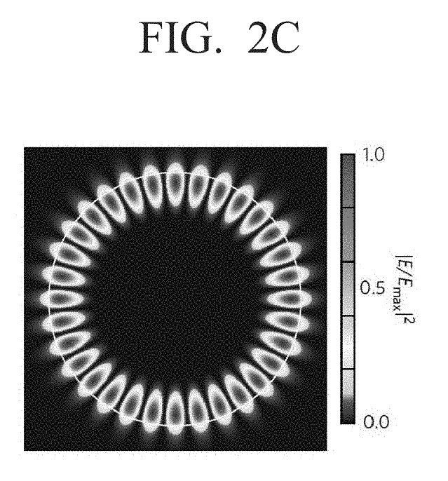

FIGS. 2A, 2B and 2C illustrate circular dielectric resonators of a homogeneous refractive index.

FIGS. 2A and 2B illustrate a rectangular coordinate system in which a complex plane w(w=u+vi) having a homogeneous lattice is mapped to a circular dielectric resonator having a homogeneous refractive index, and a trajectory of light on the rectangular coordinate system. X refers to an angle of light incident on a w plane in a resonator.

Referring to FIGS. 2A and 2B, a trajectory of light in a circular dielectric resonator may appear to he a straight line shape. The refractive indexes in the circular dielectric resonator are evenly distributed and thus, an angle of light incident on the respective areas in the circular dielectric resonator may be maintained to he a threshold angle so that a total reflection condition may be satisfied. Accordingly, the whispering gallery mode (WGM) may occur due to the total reflection of light and thus, a resonance phenomenon may occur in a circular dielectric resonator of a homogeneous refractive index. The resonance phenomenon may occur from the solution of the Helmholtz equation, which is one of quadratic partial differential equations under an outgoing boundary condition.

FIG. 2C illustrates an intensity pattern of a WGM in a circular dielectric resonator of a homogeneous refractive index.

Referring to FIG. 2C, refractive indexes in the circular dielectric resonator are homogeneous and thus, a distance between adjacent nodes that appear in the intensity pattern of the WGM is homogeneous in all boundary areas in the resonator.

The WGM may have a transverse magnetic polarization, and an azimuthal mode number (m) of the WGM may be 16. However, the value of in is not limited to the value mentioned above.

Emax refers to a maximum value of an electric field in a resonator, and a homogeneous refractive index nₒ in a circular dielectric resonator may be 1.8. However, the value of the refractive index mentioned above is merely an example to describe an example embodiment, and is not limited thereto.

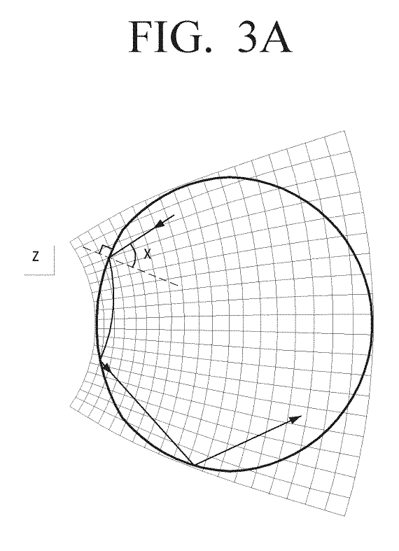

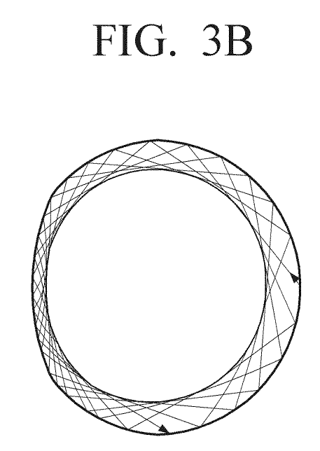

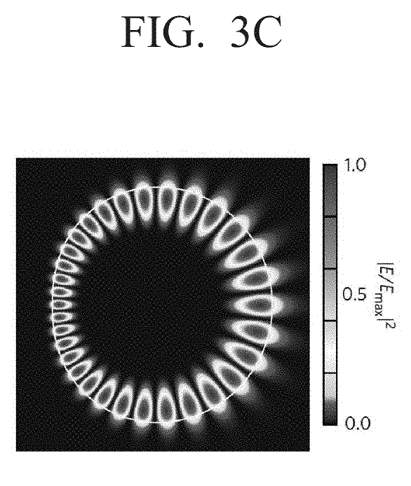

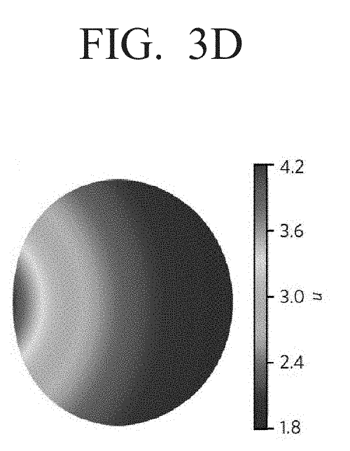

FIGS. 3A, 3B, 3C and 3D illustrate a dielectric resonator which is deformed to a limacon shape, according to various example embodiments.

FIGS. 3A and 3B illustrate a trajectory of light having a curved shape in a dielectric resonator deformed to a limacon shape, according to various example embodiments.

Referring to FIGS. 3A and 3B, a conformal transformation coordinate of a dielectric resonator of a limacon shape may be obtained according to an example embodiment to correspond to a rectangular coordinate system of a circular dielectric resonator of a homogeneous refractive index illustrated in FIG. 2A.

A complex plane (z=x+iy), which is a conformal transformation coordinate of a dielectric resonator of a limacon shape, may be obtained to correspond to a complex plane (w=u+vi) which is a rectangular coordinate of a circular dielectric resonator illustrated in FIG. 2A. An approach to obtain a z plane may be started from a deformed boundary which is called Pascal's limacon. The Pascal's limacon equation may be represented as follows, using a polar coordinate system (r, θ).

r(θ)=1+2α cos θ (1)

In Equation (1), α refers to a deformation parameter.

A coordinate transformed to a z plane which is a conformal transformation coordinate of a dielectric resonator of a limacon shape may be represented as follows, to correspond to a complex plane (w=u+vi) which is a rectangular coordinate of a circular dielectric coordinate according to an example embodiment.

z=β(w+αw²) (2)

In Equation (2) shown above, the w and the z refer to a complex variable indicating a position on two complex planes, respectively. The β refers to a positive scaling factor of an amount given to a function of α.

The conformal transformation coordinate obtained by the method described above may be mapped to a dielectric resonator of a limacon shape according to an example embodiment. A refractive index in a dielectric resonator of a limacon shape may be set so that an incident angle of light in the dielectric resonator of a limacon shape according to an example embodiment mapped to a z plane which is a transformation coordinate satisfies a total reflection condition. A refractive index in a dielectric resonator of a limacon shape may be set differently according to a spatial position and thus, refractive indexes in the dielectric resonator of a limacon shape may have different values.

When refractive indexes in the dielectric resonator of a limacon shape mapped to a conformal transformation coordinate which is a z plane are set differently, the same resonance phenomenon as a resonance phenomenon occurring in a circular dielectric resonator of a homogeneous refractive index may occur in the dielectric resonator of a limacon shape. In order for the resonance phenomenon described above to occur, the solution of the Helmholtz equation as shown below may be used.

[∇²n²(x,y)k²]E(x,y)=0 (3)

In Equation (3) shown above, the ∇² may be defined as a 2D Laplacian. The E(x, y) may be defined as a normal component of an electrical field on a z plane corresponding to each of x and y. The k may be defined as a free space wavenumber. The refractive index n(x, y) may be defined by the formula as shown below.

$$n ( x , y ) = \{ \begin{matrix}{n}_{0} {\vert \frac{dz}{dw} \vert}^{- 1} = \frac{{n}_{0}}{β \vert \sqrt{1 + 4 α z \text{/} β} \vert} , & inside the cavity \\ 1 , & outside the cavity\end{matrix} \qquad ( 4 )$$

By the formula shown above, unlike a circular dielectric resonator with a homogeneous refractive index, a refractive index n(x, y) in a dielectric resonator of a limacon shape according to an example embodiment may be set, and a refractive index n(x, y) of different values in the dielectric resonator of a limacon shape may be set. A refractive index outside may be defined as a free space where nₒᵤₜ=1. However, the refractive index outside mentioned above is merely to provide explanation according to an example embodiment, and is not limited thereto.

In addition, the conformal mapping by the formula mentioned above may be applied in a resonator according to an example embodiment and thus, a conformal transformation coordinate in a dielectric resonator of a limacon shape according to an example embodiment may be obtained.

A path of light inside a resonator according to an example embodiment may be adjusted by a change of a refractive index n(x, y). The inner refractive index n(x, of the resonator according to an example embodiment may be adjusted to a ratio of a local length scale on a w plane to a local length scale on a z plane.

In a case in which a refractive index nₒᵤₜ outside a dielectric resonator of a limacon shape according to an example embodiment is 1, a condition for the light to be totally reflected inside the dielectric resonator of a limacon shape may be |dz/dw|−1≥1 or β≤βₘₐₓ=1/\sqrt{1+4α(1+α)}.

If the condition mentioned above is met, an incident angle of light in each of the boundary areas inside the dielectric resonator of a limacon shape may be a threshold angle and thus, a total reflection of light may occur.

The refractive index n(x, y) within the dielectric resonator of a limacon shape according to an example embodiment may be set by substituting values with nₒ=1.8, α=0.2 and β=βₘₐₓ=0.714. However, the parameter values mentioned above are merely an example to describe an example embodiment, and is not limited thereto.

Accordingly, although a trajectory of light is a straight line in a homogeneous lattice of a w plane of a circular dielectric resonator illustrated in FIG. 2A, a lattice of a z plane of a dielectric resonator of a limacon shape according to an example embodiment may be curved and a trajectory of light may be a curved line. The incident angle of light having the shape of a curved line mentioned above may be maintained the same as an incident angle χ of light on the w plane, and the incident angle χ of the light may be a threshold angle in the respective boundary areas in a dielectric resonator of a limacon shape.

Accordingly, in a dielectric resonator of a limacon shape according to an example embodiment, a WGM of a high Q-factor identical to a shape of WGM occurring in a circular dielectric resonator may occur.

An intensity pattern of a high Q-factor of a non-circular dielectric resonator according to an example embodiment may be calculated in a physical (x, y) space by a virtual space Green's function by the introduction of an auxiliary virtual space (u, v) derived from a (x, y)—space through a conformal mapping. In addition, a resonance phenomenon of a non-circular dielectric resonator according to an example embodiment may be obtained by a finite element method (FEM). However, the example is not limited thereto.

The conformal whispering gallery mode (cWGM) expressed in the specification refers to a whispering gallery mode (WGM) which occurs in a non-circular dielectric resonator.

FIG. 3C illustrates an intensity pattern of a cWGM which is limited to a vicinity of a boundary area of a resonator of a deformed limacon shape, according to an example embodiment.

FIG. 3D illustrates a refractive index that differs depending on a spatial position in a resonator of a limacon shape, according to an example embodiment.

Referring to FIGS. 3C and 3D, a distance between adjacent nodes that appear in an intensity pattern of the cWGM according to an example embodiment may be formed to be close in an area in which a refractive index is high, and a distance between the adjacent nodes may be formed to be far in an area in which a refractive index is low. The feature mentioned above, according to an example embodiment is different from a case where a distance between adjacent modes that appear in an intensity pattern of a WGM according to the related art is constant.

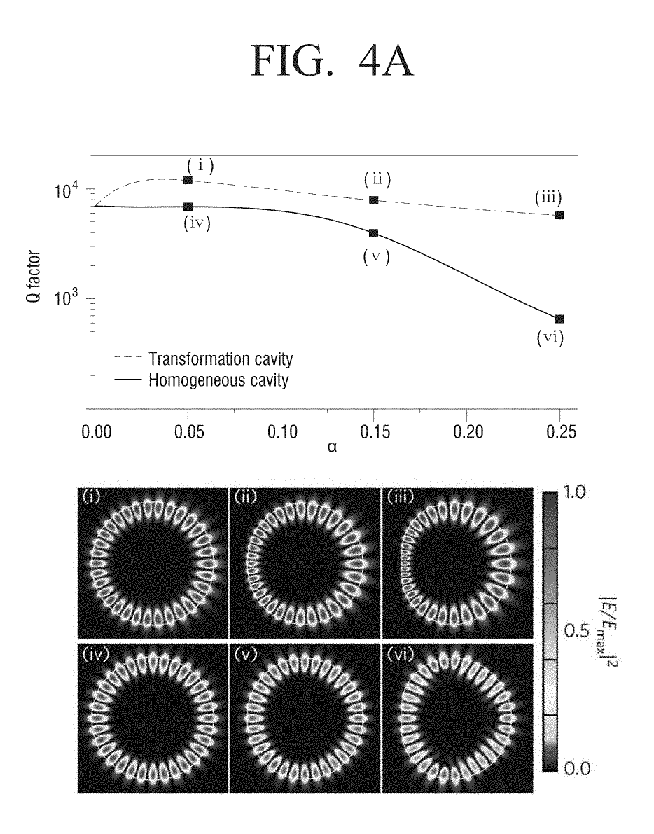

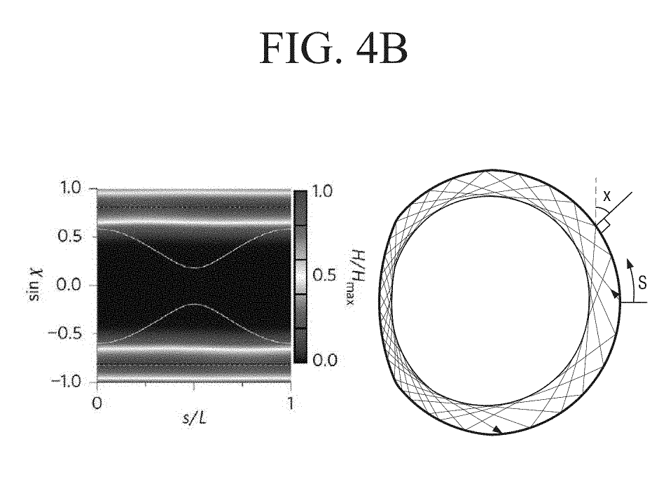

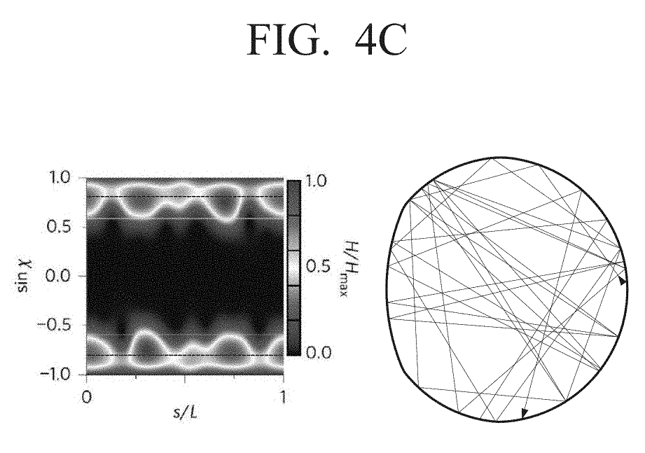

FIGS. 4A, 4B and 4C illustrate a result of comparison of a dielectric resonator of a limacon shape of which a refractive set is set with a dielectric resonator of a limacon shape of a homogeneous refractive index, according to various example embodiments.

FIG. 4A illustrates a comparison of a Q-factor of a dielectric resonator of a limacon shape in which a refractive index is set according to an example embodiment while changing a value of a deformation parameter α included in the Equation (1) shown above, with that of a dielectric resonator of a limacon shape in which a refractive index is homogeneously maintained.

According to an example embodiment, in a resonance mode of a circular shape (α=0), an azimuthal mode number (m) of a WGM may be 16. However, the value of in is not limited to the value mentioned above.

A Q-factor in a resonator deformed according to an example embodiment may have a similar value to a Q-factor in a case where a value of α is 0, even if a value of the deformation parameter α is changed to 0.25.

Referring to the images (i), (ii) and (iii) of FIG. 4A, an intensity pattern of a cWGM in a resonator deformed according to an example embodiment is limited along a resonator boundary area.

In contrast, a Q-factor of a resonator of a limacon shape of a homogeneous refractive index may be exponentially reduced if a value of the deformation parameter α exceeds 0.12.

Referring to the images, (iv), (v) and (vi) of FIG. 4A, an intensity pattern in a resonator of a limacon shape of a homogeneous refractive index may show a pattern that as a value of the deformation parameter α is increased, the intensity pattern escapes from a boundary area of the resonator and deformed to a polygonal pattern, which means that photodynamics inside a resonator of a limacon shape of a homogeneous refractive index has entered a state of chaos.

FIGS. 4B and 4C illustrate a case where a cWGM of a resonator deformed to a limacon shape according to an example embodiment and a WGM of a resonator deformed to a limacon shape of a homogeneous refractive index are represented in a phase space. To represent them in a phase space, a Husimi function (H(s, sin χ)) may be used. (left)

In the Husimi function, the s refers to a coordinate in a boundary area. The Husimi function on an interface of a dielectric may be obtained by overlap of Gaussian wave packet and a system resonance mode in a phase space.

Referring to FIG. 4B, the s of a Husimi function of a cWGM refers to a value normalized to L, which is a length of a boundary area of a resonator deformed to a limacon shape according to an example embodiment. In the Husimi function, the sin χ refers to a value of m/(nkR). The χ refers to a value which is almost the same as an incident angle allowing the light to be totally reflected inside the resonator. The m refers to an azimuthal mode number. The n refers to a refractive index inside the resonator. The k refers to a free space wavenumber. The R refers to a radius in a circular resonator.

A maximum value of the Husimi function H(s, sin χ) for a cWGM of a dielectric resonator of a limacon shape of which a value of a deformation parameter α is 0.25 is indicated by dotted lines at a position where a sin χ on a vertical axis is approximately ±0.8108. However, the values of the sin χ and the α are merely an example to describe an example embodiment, and are not limited thereto.

In a case in which a sign of sin χ is (+), it means that a wave component is rotated anticlockwise (ACW) within a resonator. In a case in which a sign of sin χ is (−), it means that a wave component is rotated clockwise (CW) within a resonator. The dotted line of which the sin χ has a maximum value of approximately 0.8108 is positioned at a higher position than a critical line indicated by a solid line. The critical line indicates that a wave is totally reflected within a resonator and thereby locked up completely. Accordingly, a Q-factor of the cWGM of a resonator deformed to a limacon shape may appear to be higher according to an example embodiment. In addition, a distance between a line (dotted line) which is the maximum value of the H(s, sin χ) and a critical line (solid line) close to the line of the maximum value may be minimized at the opposite ends (where s/L is 0 and 1) of the Husimi distribution.

The right image of FIG. 4B illustrates a trajectory of light of a resonator deformed to a limacon shape according to an example embodiment. An incident angle χ of a ray trajectory may be arcsin(0.8108). As the trajectory of light is totally reflected within a resonator according to an example embodiment, a caustic of a circular shape may be formed within the resonator. In addition, the light trajectory may be limited to an area between a boundary area and a caustic by a total reflection of the light. As illustrated in the image illustrated in (ii) and (iii) of FIG. 4A, an intensity pattern of the cWGM is formed according to a light trajectory.

In contrast, referring to FIG. 4C, a Husimi function (H(s, sin χ) of a resonator deformed to a limacon shape having a homogeneous refractive index and a value of the deformation parameter α of 0.25 is illustrated (left). A solid line indicates that a critical angle for an internal total reflection is constant. As described above, an intensity pattern of a dielectric resonator of a limacon shape having a homogeneous refractive index and a value of the deformation parameter α of 0.25 is a polygonal pattern, which indicates that a ray photodynamics within the resonator is in a state of chaos. When the resonator is internally in a state of chaos, a maximum value in a Husimi function may not be constant and an incident angle may be beyond a critical angle at which a total reflection is possible. Accordingly, a WGM may no longer appear in a dielectric resonator of a limacon shape of a homogeneous refractive index.

The right image of FIG. 4C illustrates a state in which a light trajectory is in a state of chaos. A total reflection of light may occur in a dielectric resonator of a limacon shape of a homogeneous refractive index, but a total reflection of light may not occur in a case in which a light is incident at a smaller angle than a critical angle. Accordingly, the light is not limited to a total internal reflection and thus may be refracted outside the resonator and escape from the resonator and a Q-factor may be maintained to be a high value.

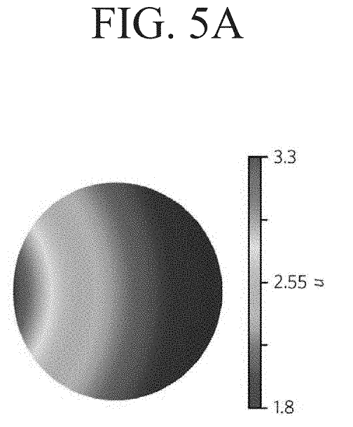

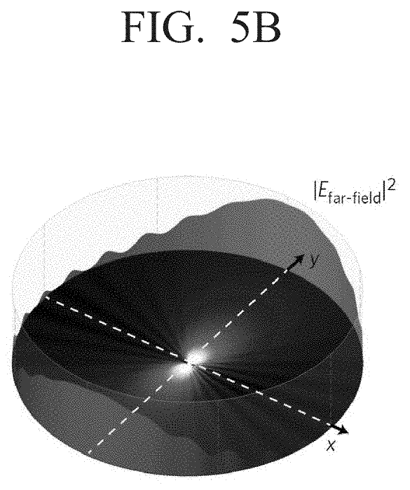

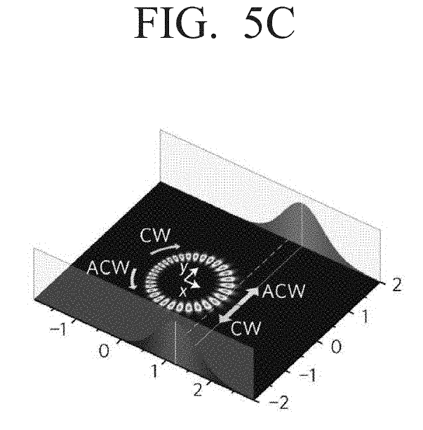

FIGS. 5A, 5B and 5C illustrate a bidirectional light emission characteristic of a light in a dielectric resonator deformed to a limacon shape, according to various example embodiments.

FIG. 5A illustrates a dielectric resonator deformed to a limacon shape of which a value of the deformation parameter α is 0.15 and an internal refractive index distribution according to an example embodiment.

FIG. 5B illustrates an intensity of light measured at a far distance from a cWGM of which a value of the deformation parameter α is 0.15 and an azimuthal mode number (m) is 16 according to an example embodiment.

Referring to FIG. 5B, a cylinder screen may be disposed at a position corresponding to hundred times (100R) of a radius of a dielectric resonator deformed and a bidirectional far-field distribution may be displayed at a side surface of a cylinder and an intensity distribution of light emission may be indicated on a bottom surface of the cylinder.

According to an example embodiment, a light is limited to a total reflection inside a resonator and thus, a directional light emitted to a y-axis direction is not a light emitted by refraction. The light emitted from a cWGM to the y-axis direction is not directly emitted from a boundary area of a resonator according to an example embodiment. Accordingly, the feature described above cannot be explained by Snell's law which is valid between directions of an incident light and a refracted light when a light is refracted at a boundary between two different equal-in-direction, non-conductive media. The above-described directional emission may be a tunneling emission due to a characteristic of a wave in which no light trajectory is present. A phenomenon of tunneling emission may be identified by an output emitted along a tangential direction that comes from a boundary area of a resonator to a free space point.

FIG. 5C illustrates a result of identifying an intensity distribution of a near-field from a projection plane near a resonator of a limacon shape to identify a tunneling emission for which a light is emitted out from the resonator.

Referring to FIG. 5C, the projection plane may be vertically set in the y-axis direction on which a far-field is at its maximum, and a vertical incident component of a near-field may be projected onto the plane mentioned above. A light may be tunnel-emitted outside from a boundary area in which a refractive index is the lowest from among a boundary area of a non-circular dielectric resonator according to an example embodiment. The boundary area having the lowest refractive index may be the right end of a non-circular dielectric resonator according to an example embodiment. However, the position described above is merely an example to describe an example embodiment, but is not limited thereto.

In addition, a tunneling emission in a dielectric resonator deformed according to an example embodiment may be a bidirectional near-field emission. A tunneling emission of CW and ACV wave components may be indicated by dotted lines indicated at a peak part of a near-field intensity illustrated on a projection plane. The dotted lines indicated in FIG. 5C refer to a tangential line in a boundary area of a resonator closest to the solid line mentioned above. It can be understood that the above-mentioned result matches with a result that a distance between a line (dotted line) which is a maximum value of H(s, sin χ) and a critical line (solid line) closest to the line of the maximum value can be minimized at both ends (where s/L is 0 and 1) of a Husimi distribution.

In a related-art deformed dielectric resonator, the largest bending loss occurs at a point where a boundary curvature is largest and thus, the leakage of light may be maximized at the point where a boundary curvature is largest. However, a mechanism through which a light is emitted from a dielectric resonator deformed according to an example embodiment may be determined based on a ratio of a refractive index outside of the deformed dielectric resonator to a refractive index that differs according to the respective boundary areas. Accordingly, a related-art deformed dielectric resonator and a dielectric resonator deformed according to an example embodiment may emit light in different ways.

The bidirectional emission of light occurring in a limacon dielectric resonator deformed according to an example embodiment may be implemented as a unidirectional light emission by selecting an appropriate shape of boundary area of a resonator along with an internal refractive index distribution.

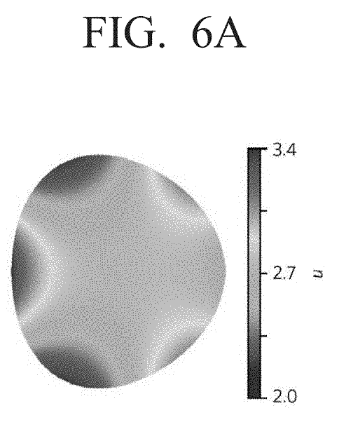

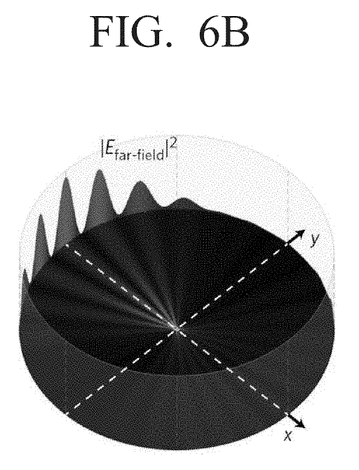

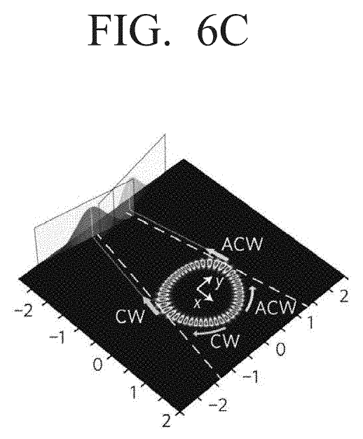

FIGS. 6A, 6B and 6C illustrate a unidirectional emission characteristic of a light in a dielectric resonator deformed to a triangular, constant-width shape, according to various example embodiments.

FIG. 6A illustrates a dielectric resonator of a constant-width shape of a triangle shape deformed according to an example embodiment and a refractive distribution in the resonator. A conformal transformation coordinate of a dielectric resonator of a triangular, constant-width shape may be obtained to correspond to a rectangular coordinate system of a circular dielectric resonator. The conformal transformation coordinate may be obtained by conformal mapping z(w). The z(w) may be represented as in the formulas as shown below.

$$z ( w ) = {z}_{3} {z}_{2} {z}_{1} ( w ) , {z}_{1} ( w ) = α ( w + δ ) \text{/} ( 1 + w δ ) , \\ {z}_{2} ( w ) = i ( 1 + w ) \text{/} ( 1 - w ) , \\ {z}_{3} ( w ) = {\int }_{0}^{w} {{e}^{i π / 6} ( h + 1 )}^{- 2 / 3} {( h - 1 )}^{- 2 / 3} d h \qquad ( 5 )$$

In the equations shown above, the control parameter α may be defined as 0<α≤1, and a shape of a boundary area of a dielectric resonator may be deformed from a triangular, constant-width shape (α=1_{—} to a circular shape (α«1). In the equations shown above, the control parameter δ may be defined as a complex value in a boundary area of a resonator, and the δ may change a refractive index distribution without deforming a shape of a boundary area of the resonator. If δ is a real number, the conformal mapping may be mapped to have a mirror symmetry with respect to a horizontal axis. The horizontal axis mentioned above may be an x-axis in an example embodiment. However, the example is not limited thereto.

A dielectric resonator of a triangular, constant-width shape according to an example embodiment may be deformed by a value of (α, δ)=(0.68, 0.2). However, the value described above is merely an example to describe an example embodiment, but is not limited thereto.

Referring to FIGS. 6B and 6C, when the light emitted in two directions is directed in parallel to the axis of symmetry, a light of a unidirectional emission may be obtained.

Referring to FIG. 6B, a unidirectional far-field distribution of a cWGM according to an example embodiment is shown on a cylinder screen which is a circle of which a radius is 100R. A unidirectional far-field emission of a cWGM light may be a tunneling emission rather than an emission by refraction. An intensity distribution of the emitted light may be indicated on a bottom surface of a cylinder.

FIG. 6C illustrates a result of identifying an intensity distribution of a near-field from a projection plane near a dielectric resonator of a triangular, constant-width shape according to an example embodiment to identify tunneling emission from the resonator. An azimuthal mode number (m) of a cWGM according to an example embodiment may be 22. However, the value of in described above is merely an example to describe an example embodiment, but is not limited thereto.

Referring to FIG. 6C, a projection plane may be perpendicular to a direction in which a far-field illustrated in FIG. 6C is at its maximum. In a case of strong asymmetry between the CW and ACW wave components at the emission point of the boundary area in the dielectric resonator deformed according to an example embodiment, a unidirectional emission of light may be obtained.

A tunneling emission of the CW and ACW wave components may be respectively indicated by dotted lines indicated at a peak part of a near-field intensity illustrated on a projection plane. The respective dotted lines indicated in FIG. 6C refer to a tangential line in a boundary area of a resonator closest to the respective solid lines mentioned above.

Accordingly, emission of unidirectional light according to an example embodiment may occur when there is a significant difference between the emission of two parallel lights and the intensity of the wave components rotating in opposite directions at each emission point.

A particular geometric symmetry may be added to a conformal mapping according to an example embodiment and thereby, the light emitted outside of a resonator may be multi-directional. The multi-directionality may be configured to indicate three or four directions, but is not limited thereto.

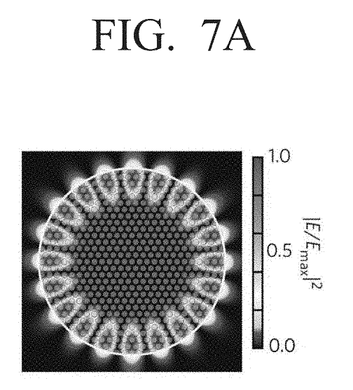

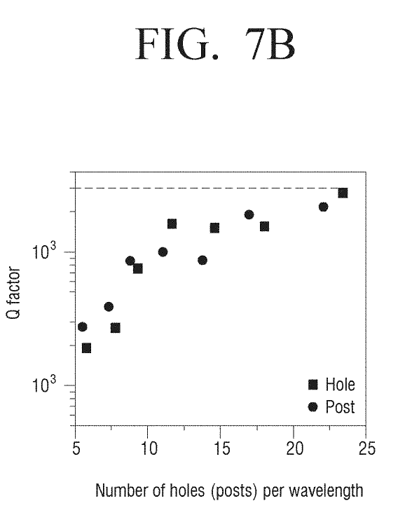

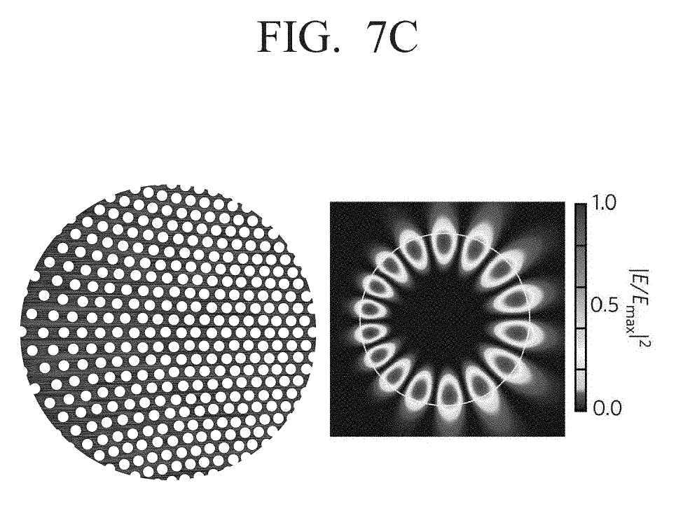

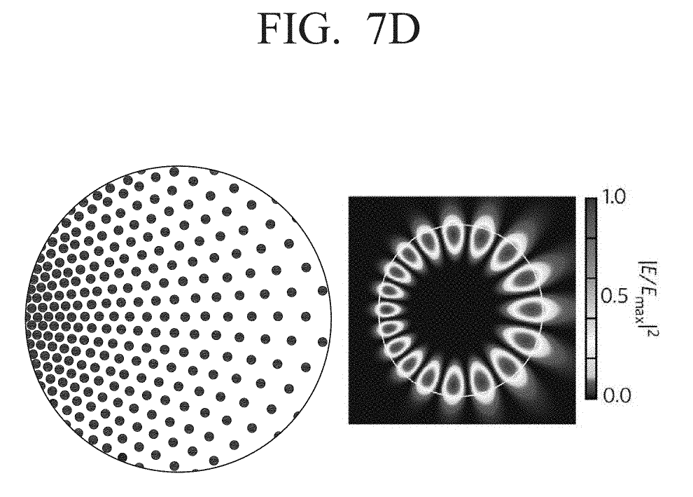

FIGS. 7A, 7B, 7C and 7D illustrate figures in which a WGM and a cWGM in a resonator implemented by a hole and a post are numerically realized.

Referring to FIG. 7A, in an example embodiment, a circular resonator is implemented by uniformly making an air hole on a subwavelength scale in a dielectric slab or uniformly arranging dielectric posts having a high refractive index, and a WGM intensity pattern of the implemented circular resonator is shown.

According to an example embodiment, a hole refractive index (n) in a circular resonator implemented by an air hole according to an example embodiment may be implemented as 1, and a refractive index (n) of a dielectric disk substrate for the hole may be implemented as 3.4. As a result, a circular resonator in which an effective refractive index (n_{eff}) is 2.5 may be implemented.

In addition, according to an example embodiment, a post refractive index (n) in a circular resonator implemented by a dielectric post according to an example embodiment may be implemented as 3.4, and a refractive index (n) of a dielectric disk substrate for the post may be implemented as 1.4. As a result, a circular resonator in which an effective refractive index (n_{eff}) is 2.5 may be implemented.

However, the value of refractive index described above is only an example according to an example embodiment, but is not limited thereto.

FIG. 7B illustrates a Q-value which is changed according to an increase of density of a hole or a post while an effective refractive index (n_{eff}) is maintained at 2.5 in a circular resonator illustrated in FIG. 7A according to an example embodiment.

Referring to FIG. 7B, it is shown that Q-factor values are converged according to an increase of scatters (holes or posts)per wavelength. If the number (free space wavelength/n_{eff}) of scattters (holes or posts) per wavelength is greater than 20, the Q-factor may be converged to within 10% of an ideal Q-factor indicated by dotted lines. The convergence to an ideal Q-factor may be shown according to reduction of a loss of scatters in a circular resonator in which a distribution of refractive index is homogeneous.

FIG. 7C illustrates a resonator (left) deformed to a limacon shape using a distribution of holes and a cWGM intensity pattern (right) of the deformed resonator.

Referring to FIG. 7C, the dielectric resonator of a limacon shape implemented by holes distributed on a dielectric substrate having a refractive index (n) of 3.4 refers to a resonator in which the a in equation (1) is implemented as 0.08. In addition, a dielectric resonator of a limacon shape illustrated on the right refers to a cWGM intensity pattern when a finite element method (FEM) is used and an azimuthal mode number (m) is 8. However, the values of n, in and a mentioned above are values presented to explain an example embodiment, but are not limited thereto.

FIG. 7D illustrates a dielectric resonator (left) deformed to a limacon shape using a distribution of posts and a cWGM intensity pattern (right) of the deformed dielectric resonator.

Referring to FIG. 7D, the dielectric resonator of a limacon shape implemented by posts having a refractive index (n) of 5 distributed on a dielectric substrate having a refractive index (n) of 1.4 refers to a resonator in which the a in equation (1) is implemented as 0.15. In addition, a dielectric resonator of a limacon shape illustrated on the right refers to a cWGM intensity pattern when an azimuthal mode number is 9 by using a finite element method (FEM). However, the values of n, m and α mentioned above are values presented to explain an example embodiment, but are not limited thereto.

The images illustrated in FIGS. 7C and 7D show that a distance between nodes is reduced in a boundary area of which an effective refractive index is higher than other boundary areas from among boundary areas of a dielectric resonator of a limacon shape. Accordingly, according to an example embodiment, the feature that a distance between the nodes decreases as an effective refractive index increases matches with a result that an area has a higher refractive index as a distance between adjacent nodes are reduced in an intensity pattern of a resonator of a limacon shape illustrated in FIG. 3C.

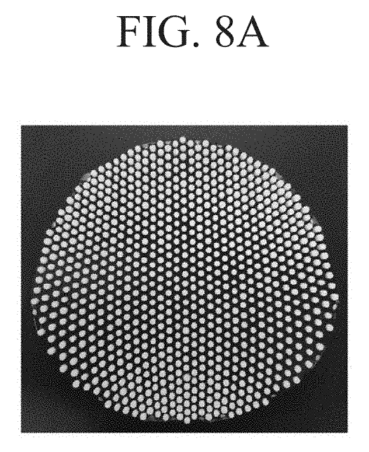

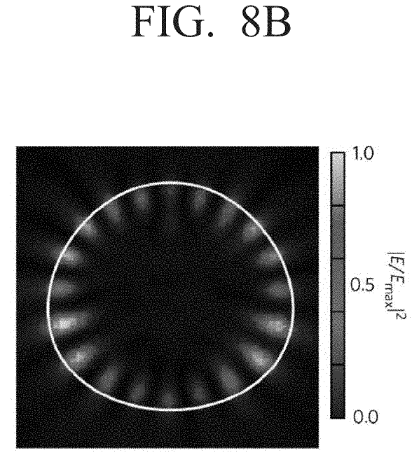

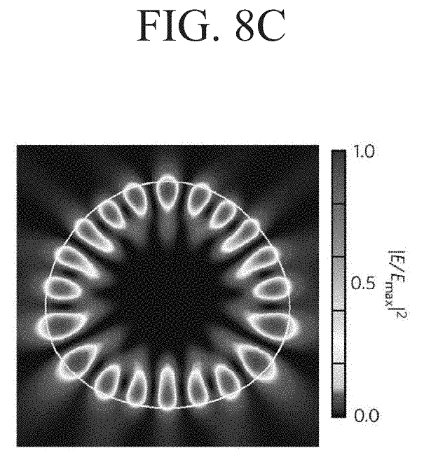

FIGS. 8A, 8B and 8C illustrate a shape and intensity pattern of a dielectric resonator deformed to a triangular, constant-width shape implemented by an alumina post at a micro-frequency.

Referring to FIG. 8A, in an example embodiment, it is illustrated a resonator in which an aluminum oxide post having a diameter of 6mm and a refractive index (n) of 3.1 is fixed in a triangular, constant-width shape on a polyvinyl chloride (PVC) foaming sheet which is 2 mm thick. In addition, a resonator in which the nₒ=1.8, the α=0.58 and δ=0.2 in the equation (5) shown above is shown.

According to an example embodiment, in general, an alumina post tends to be highly permittive, and since it is fixed on a PVC foaming sheet of a thickness as thin as 2 mm, an experiment is conducted on the assumption that a permittivity of a substrate is a permittivity of air.

In addition, according to an example embodiment, a value of refractive index (nₒ) may be selected to match a range of refractive index realizable by a distribution of alumina posts.

However, the values of nₒ, α and δ described above are merely exemplary to describe an example embodiment, but are not limited thereto.

Referring to FIG. 8B, an intensity pattern at a resonance frequency of a cWGM according to an example embodiment is shown. The resonance frequency is 2.6481 Hz in an example embodiment, but this is only an example. cWGM intensity pattern obtained from an experiment matches with an intensity pattern of a deformed resonator implemented as an actual alumina post calculated from a finite element method (FEM) modeling.

Referring to FIG. 8C, according to an example embodiment, a cWGM intensity pattern of a resonator deformed from a circular resonator according to an example embodiment may be limited according to a boundary area of the resonator, and a distance between adjacent nodes or antipodes may be changed according to a change of refractive index distribution of a boundary area of each of deformed resonators.

The foregoing embodiments and advantages are merely exemplary and are not to be construed as limiting the present disclosure. The present teaching can be readily applied to other types of apparatuses. Also, the description of the example embodiments is intended to be illustrative, and not to limit the scope of the claims, and many alternatives, modifications, and variations will be apparent to persons having ordinary skill in the art.

What is claimed is:

1. A method for designing a non-circular dielectric resonator, the method comprising:
obtaining a conformal transformation coordinate f the non-circular dielectric resonator to correspond to a rectangular coordinate system of a circular dielectric resonator;
mapping the obtained conformal transformation coordinate to the non-circular dielectric resonator; and
setting a refractive index in the non-circular resonator and allowing an incident angle of light to satisfy a condition for total reflection in each of boundary areas in a non-circular dielectric resonator to which the conformal transformation coordinate is mapped.

2. The method as claimed in claim 1, further comprising:
tunnel-emitting the light outside from a boundary area of which the refractive index is lowest from among boundary areas of the non-circular dielectric resonator.

3. The method as claimed in claim 1, wherein refractive indexes in the non-circular resonator have different values.

4. The method as claimed in claim 1, wherein the setting the refractive index in the non-circular resonator comprises setting the refractive index by adjusting at least one of a permittivity and a permeability.

5. The method as claimed in claim 1, wherein the non-circular dielectric resonator has a shape of one of a limacon, an oval, and a curve of constant width.
